(19) United States
(12) Patent Application Publication
(10) Pub. No.: US 2017/0149826 A1
(43) Pub. Date: May 25, 2017

(54) System For Data Protection In An Emplyee Private Mobile Devices

(71) Applicant: APPDOME LTD., Tel Aviv (IL)

(72) Inventors: Avner Yehuda, Ramat Gan (IL); Hadar Lotan, Ramat Gan (IL)

(73) Assignee: APPDOME LTD., Tel Aviv (IL)

(21) Appl. No.: 14/578,540

(22) Filed: Dec. 22, 2014

(51) Int. Cl. H04L 29/06

(52) U.S. Cl. CPC H04L 63/20

(57) ABSTRACT

As employees carry their own private mobile devices (smart phones, tablets) and companies would like to allow them to keep being effective and use company data, Ii s becoming impossible for the IT to control the data in a user mobile device with unknown applications.

The present invention will describe a system and method which will allow implementing the IT policy over company data in an employee mobile device using any type of an application.

### BACKGROUND

To protect mobile devices existing security solutions such as encryption, anti-virus, cyber protection tools are used.

For mobile phones, once it is detected that they are lost or stolen data can be erased or the device locked.

Pin codes are being used to activate the device.

There are no method to enforce a flexible policy based on the data type, employee type and the device status.

There are no methods to protect against a careless behavior of a misbehavior of the employee.

### BRIEF DESCRIPTION OF THE DRAWINGS

FIG. 1 is the system description

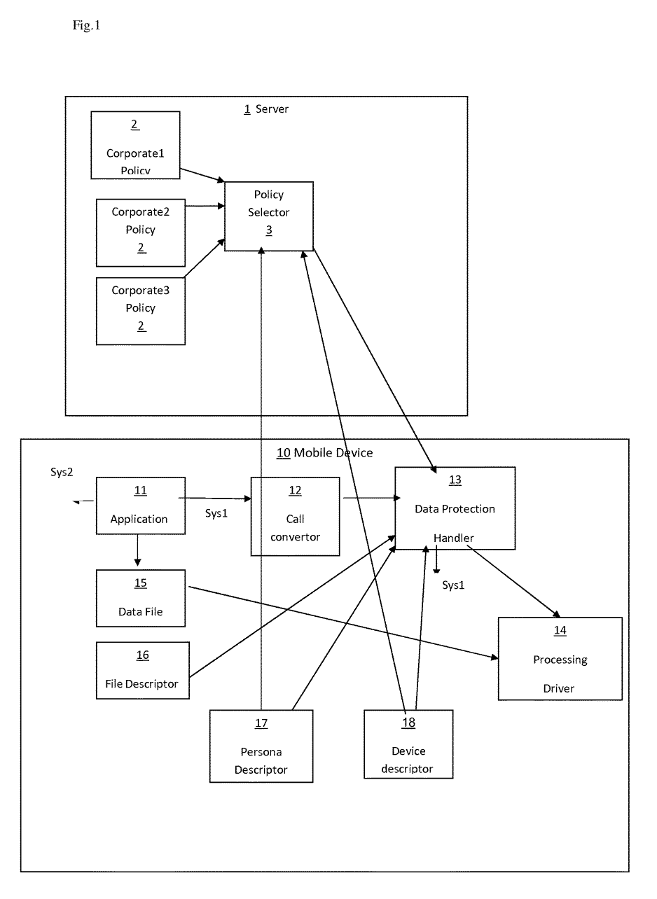

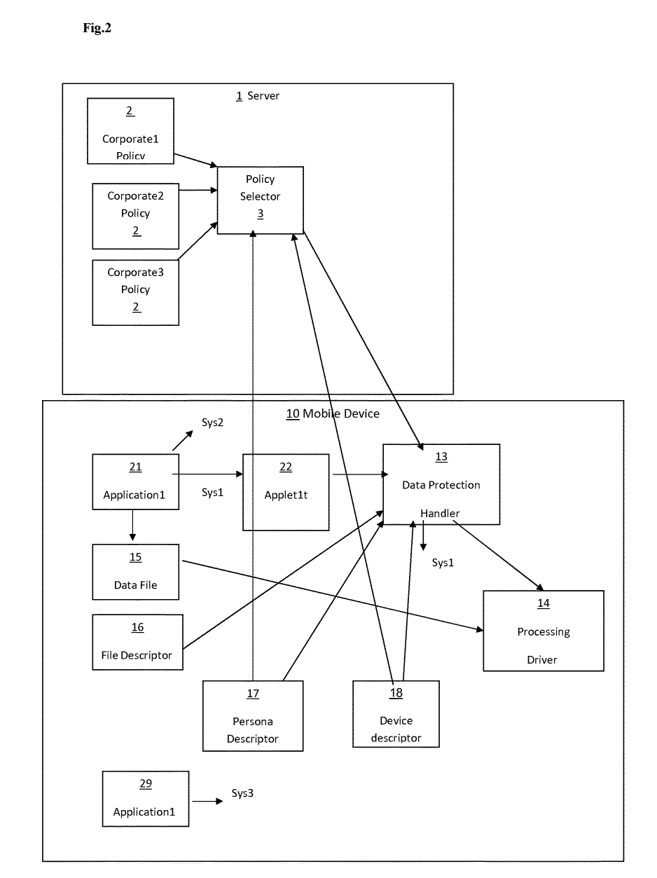

### SUMMARY

System calls may be converted to calls to protection handler, which based on picking the right protection policy will decide based on information on the data type, user type and device status on how to handle the data.

### DETAILED DESCRIPTION

The following description describes a system for protecting corporate data residing in employee mobile devices from undesired operations on the corporate data by applications on the mobile device side.

This may be just modifying the data or transferring it.

Under the first embodiment, a system call target conversion mechanism as described in patent application Ser. No. 13/846,953 and patent application 20100175104 is used. All application calls to a certain system call are being converted to another address.

The system is based on a corporate server 1 and multiple mobile devices 10. An employee might have multiple such devices.

The server may have in multiple corporate protection policies 2.

A policy selector will select the appropriate policy based on a user personal descriptor 17 and device descriptor 18. It is possible that for the same user there will be different policies depending on the device descriptor—is this a notebook or a phone? Where is it?

It is also possible that there will be a single policy for the company with references to the descriptors.

If an application is referencing a certain data file, it will be redirected through the applet wrapper to the handler driver. It will read the file descriptor and the relevant company policy indicated by the descriptor and will decide based on the data descriptor and the policy if to allow the system call. It can jus prevent it or cause another system call instead.

In the mobile device 10 an application 11 will be activated. It may issue a system call SYS1 1 which refers to data file 15. The data file may 1 have a data descriptor attached to it, if it is protected.

A call converter 12 might be activated due to Sys1 call. In any case, if the method is capable of detecting and handling a call, the call will be converted to a call to data protection handler 13. The call converter will not be activated by other system calls, such as Sys2.

The handler will examine the following information:

1. Calling application

2. System call type

3. Data descriptor (what type of data, to which company the data belongs—it is possible the user is working for multiple companies)

4. User personal information (type of job, years in the company, grade etc.

5. Device data—this includes type of device, ownership, time, location.

6. Protection policies—the user may be working for multiple companies, potentially a policy per each.

The handler will pick the appropriate policy based on the data file ownership, and based on the policy and the descriptors will decide if to which processing driver 14 to call. This may be the original target or system call or any other type of service—this may be jus a message which will instruct the user it is not allowed to do such an operation. It may allow the call to path, ignore it, convert it to another system call or do data processing.

Also, per patent application 61/865,152 a system and method are described where different sections of a file have each a different encryption key, such that per user or condition different segments can be encrypted. If the data file was prepared in such a way than the handler will have a list of such keys and it may activate decryption software and send it the appropriate key. In such a way, if the data file is for example the company contact list, certain contacts may be visible to design engineers and other to marketing people.

If the application is referencing a file without a file descriptor this will mean that this is a reference to non protected data, and the handler will issue a call to the original system call SYS1

Under a second embodiment a system and method for system call conversion as described in patent application Ser. No. 13/846,953 is being described. In this system, an applet is generated for certain applications and certain system calls from this application are intercepted and converted to another target for special handling.

Application1 21 in FIG. 2 may issue system calls—Sys1 and Sys2. Sys2 call will not be intercepted by the system and will proceed normally.

Applet1 22 was generated to handle system calls made by application1 21.

It will take Sys1 call and convert it to a call to data protection handler 13, which will handle it as described above using descriptor information as described above

Application 29 is an unprotected application with no applet attached to it. Sys3 calls issued by it will go uninterrupted.

What is claimed is:

1. A method where appropriate corporate protection policy is chosen from corporate server based on user or data or device information.

2. A method where appropriate device policy is being selected from multiple corporate protection based on file ownership information.

3. A method where certain system calls in the device may be converted to calls for different handling.

4. A method as in claim 3 where part of the different handling may be activating a decryption software for the data file with an encryption key chosed based on the protection policy

5. A method as in claim 3 where the type of handling may be determined by the protection policy and the data type

6. A method as in claim 3 where the type of handling may be determined by the protection policy and the user type

7. A method as in claim 3 where the type of handling may be determined by the protection policy and device information

8. A method as in claim 6 where the device information may include device type, location and time.

9. A method as in claim 3 where calls from all applications to a certain system call are being converted to calls for different handling.

10. A method as in claim 3 where only calls from certain applications to a certain system calls are converted for calls for different handling.

11. A system where a call converted will convert certain system calls to calls for different handling

12. A system where a system call handler is handling certain 1 calls from a specific application.
